(19) United States
(12) Patent Application Publication
(10) Pub. No.: US 2004/0227701 A1
(43) Pub. Date: Nov. 18, 2004

(54) Plasma display panel and method for driving the same

(75) Inventors: Woo-Joon Chung, Ahsan-city (KR); Jin-Sung Kim, Cheonan-city (KR); Kyoung-Ho Kang, Suwon-city (KR); Seung-Hun Chae, Suwon-city (KR)

Correspondence Address: MCGUIREWOODS, LLP, 1750 TYSONS BLVD, SUITE 1800, MCLEAN, VA, 22102, US

(73) Assignee: Samsung SDI Co., Ltd.

(21) Appl. No.: 10/844,544

(22) Filed: May 13, 2004

(30) Foreign Application Priority Data
May 14, 2003 (KR) 2003-0030652

(51) Int. Cl. G09G 3/28

(52) U.S. Cl. 345/60

(57) ABSTRACT

Disclosed is a reset waveform of a plasma display panel. A rising or falling voltage is applied rapidly enough to cause an intense discharge in a reset interval. The electrodes are then floated to reduce the voltage applied into a discharge space during the discharge to cause a self-quenching of the discharge, thereby precisely controlling wall charges.

### CROSS REFERENCE TO RELATED APPLICATION

This application is based on Korea Patent Application No. 2003-30652 filed on May 14, 2003 in the Korean Intellectual Property Office, the content of which is incorporated herein by reference.

### BACKGROUND OF THE INVENTION

1. Field of the Invention

This invention relates to a plasma display panel (PDP) and a method for driving the same. More specifically, the present invention relates to a reset waveform driving method for PDP.

2. Description of the Related Art

Flat panel displays, such as, liquid crystal displays (LCDs), field emission displays (FEDs), PDPs, and the like are actively being developed. PDPs generally have higher luminance, higher luminous efficiency and wider viewing angles than other flat panel displays. Thus, PDPs are more favorable for making large-scale screens of 40 inches or more than, for example, the conventional cathode ray tube (CRT).

A PDP is a flat panel display that uses plasma which is generated by gas discharge to display characters or images and includes, according to its size, more than several scores to millions of pixels arranged in a matrix pattern. PDPs may be classified as direct current (DC) type and alternating current (AC) type according to the PDP's discharge cell structure and the waveform of the driving voltage applied thereto.

A DC type PDP has electrodes exposed to a discharge space to allow a direct current (DC) to flow through the discharge space while the voltage is applied, and thus, DC type PDPs generally require a resistance for limiting the current. In contrast, an AC type PDP has electrodes covered with a dielectric layer which forms a capacitance component to limit the current and which protects the electrodes from the impact of ions during a discharge. Thus, AC type PDPs generally have longer lifetimes than DC type PDPs.

FIG. 1 is a partial perspective view of an AC type PDP. FIG. 1 shows a first glass substrate 1, parallel pairs of a scan electrode 4 and a sustain electrode 5, a dielectric layer 2 and a protective layer 3. On a second glass substrate 6, a plurality of address electrodes 8, which are covered with an insulating layer 7, are arranged. Barrier ribs 9 are formed in parallel with the address electrodes 8 on the insulating layer 7, which is interposed between the address electrodes 8. A fluorescent material 10 is formed on the surface of the insulating layer 7 and on both sides of the barrier ribs 9. The first and second glass substrates 1 and 2 are arranged in a face-to-face relationship with a discharge space 11 formed therebetween, so that the scan electrodes 4 and the sustain electrodes 5 lie in a direction perpendicular to the address electrodes 8. Discharge spaces at intersections between the address electrodes 8 and the pairs of scan electrode 4 and sustain electrode 5 form discharge cells 12.

FIG. 2 shows an arrangement of electrodes in the PDP.

Referring to FIG. 2, the PDP has a pixel matrix consisting of m×n discharge cells. In the PDP, address electrodes Aₗ to Aₘ are arranged in columns and scan electrodes (Y electrodes) Yₗ to Yₙ and sustain electrodes (scan electrodes) Xₗ to Xₙ are alternately arranged in n rows. Discharge cells 12 shown in FIG. 2 correspond to the discharge cells 12 in FIG. 1.

According to the general PDP driving method, one frame is divided into a plurality of subfields, each of which is comprised of a reset interval, an address interval, and a sustain interval.

During the reset (initialization) interval, the state of wall charges from the previous sustain interval are erased and the wall charges are set up in order to stably perform the next address discharge. Generally, the reset interval is for preparing the optimal state of the wall charges for the addressing operation during the address interval subsequent to the reset interval.

The address interval is for selecting turn-on cells and turn-off cells and accumulating wall charges on the turn-on cells (i.e., addressed cells). The sustain interval is for performing a discharge to display an image on the addressed cells.

The reset interval of the conventional driving method involves applying a ramp waveform as disclosed in U.S. Pat. No. 5,745,086. In the conventional driving method, a slowly rising or falling ramp waveform is applied to the Y electrodes to control the wall charges of each electrode during the reset interval. However, the precise control of the wall charges is greatly dependent upon the slope of the ramp in the ramp waveform that is applied. Thus, in order to precisely control the wall charges, generally, a long time is required for initialization.

### SUMMARY OF THE INVENTION

This invention provides a plasma display panel and its driving method that implements initialization in a short time.

This invention separately provides a method for driving a plasma display panel, which includes a first space defined by a first electrode and a second electrode by applying a voltage to the first electrode to discharge the first space, and floating the first electrode after discharging the first space.

This invention separately provides a method for driving a plasma display panel, which includes a first space defined by a first electrode and a second electrode. During a reset interval, the method involves applying a rising voltage to the first electrode to discharge the first space, floating the first electrode after discharging the first space, applying a falling voltage to the first electrode to discharge the first space, and floating the first electrode after discharging the first space.

This invention separately provides a method for driving a plasma display panel, which includes a first space defined by a first electrode and a second electrode. During a reset interval, the method involves performing a first discharge in the first space to accumulate wall charges on a dielectric formed on at least one of the first electrode and the second electrode, quenching the first discharge, performing a second discharge in the first space to accumulate wall charges on the dielectric formed on at least one of the first electrode and the second electrode, and quenching the second discharge.

This invention separately provides a method for driving a plasma display panel, which includes a first space defined by a first electrode and a second electrode. During a reset interval, the method involves performing a first discharge in the first space to decrease wall charges accumulated on a dielectric formed on at least one of the first electrode and second electrode, quenching the first discharge, performing a second discharge in the first space to decrease the wall charges accumulated on the dielectric formed on the first electrode and the second electrode, and quenching the second discharge.

This invention separately provides a plasma display panel including a first electrode and a second electrode, a first space defined by the first electrode and the second electrode, and a driver circuit for sending a driving signal to the first electrode and the second electrode during a reset interval. The driver circuit applies a voltage to the first electrode to discharge a first space and then floats the first electrode.

This invention separately provides a plasma display panel including a first substrate and a second substrate, a first electrode and a second electrode formed in parallel on the first substrate, an address electrode formed on the second substrate, a first space defined by the first electrode and the second electrode, and a driver circuit for sending a driving signal to the first electrode, the second electrode and the address electrode during a reset interval, an address interval, and a sustain interval. During the reset period, the driver circuit applies a rising voltage to the first electrode to discharge the first space, and then floats the first electrode.

This invention separately provides a plasma display panel including a first substrate and a second substrates, a first electrode and a second electrode formed in parallel on the first substrate, an address electrode formed on the second substrate, a first space defined by the first electrode and the second electrode; and a driver circuit for sending a driving signal to the first electrode, the second electrode and the address electrode during a reset interval, an address interval, and a sustain interval. During the reset interval, the driver circuit applies a falling voltage to the first electrode to discharge the first space, and then floats the first electrode.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 is a partial perspective of an AC type PDP.

FIG. 2 illustrates an arrangement of electrodes in the PDP.

FIG. 3A shows a model of a plasma display cell for describing a driving method according to an embodiment of the present invention.

FIG. 3B is an equivalent circuit diagram of FIG. 3A;

FIGS. 4, 5 and 6 show a diagram of the plasma display cell shown in FIG. 3A which shows an electric charge, wall charges and a voltage in the discharge space.

FIG. 7 is a diagram of a PDP according to an embodiment of this invention.

FIGS. 8A and 8B are reset waveform diagrams according to a driving method of a first embodiment of this invention.

FIG. 9 is a diagram showing an electrode voltage, wall voltage, and a discharge current according to the driving method of the first embodiment of this invention.

FIG. 10 is a conceptual diagram of a circuit implementing a driving method according to a second embodiment of this invention.

FIG. 11 is a waveform diagram according to the driving method of the second embodiment of this invention.

FIGS. 12A, 12B and 12C are detailed diagrams of the reset waveform of FIG. 11.

FIGS. 13A and 13B are diagrams showing an electrode voltage, wall voltage, and a discharge current according to the driving method of the second embodiment of this invention.

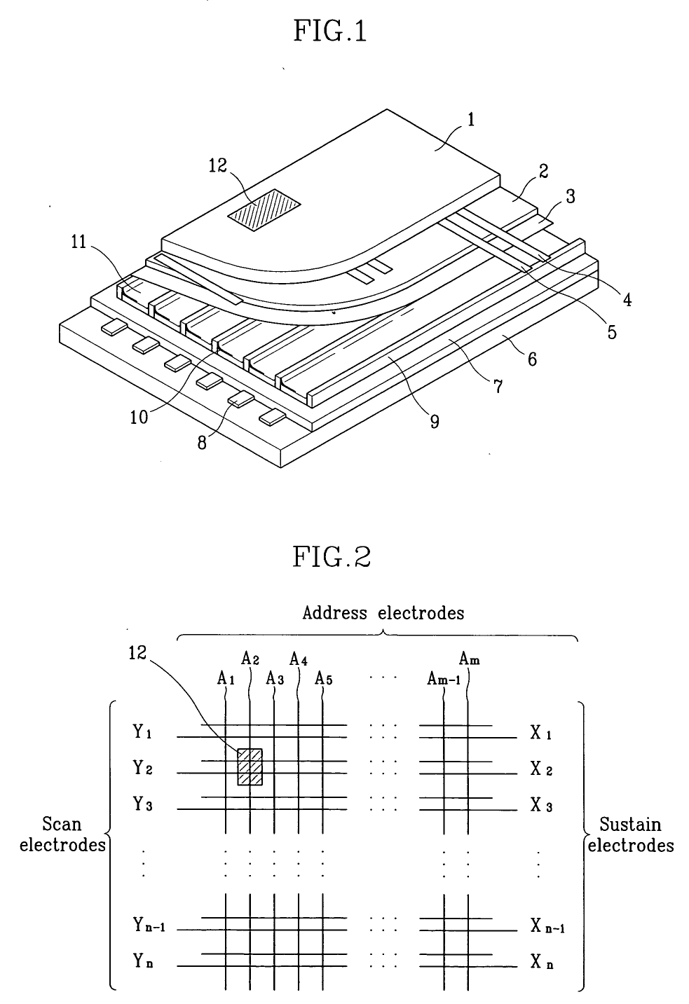

### DETAILED DESCRIPTION OF THE PREFERRED EMBODIMENTS

In the following detailed description, only the exemplary embodiments of the invention have been shown and described. As will be realized, the invention is capable of modification in various obvious respects, all without departing from the invention. Accordingly, the drawings and description are to be regarded as illustrative in nature, and not restrictive.

The method for driving a plasma display panel according to an embodiment of the present invention involves increasing or decreasing an applied voltage rapidly enough to cause an intense discharge during a reset interval and then reducing a voltage applied to the inside of a discharge space during the discharge to cause a self-quenching of the discharge, thereby controlling wall charges. According to the embodiment of the present invention, the self-quenching of the discharge can be implemented using the floating state of electrodes.

A predetermined time period called a “discharge delay” is the time period after application of a voltage until discharge of a discharge space. The process beginning after application of a voltage until a discharge will be described below.

When at least one of the two electrodes (two of X and Y electrodes and address electrodes) represented by a capacitive load is coupled to a power source, the two electrodes are charged with electric charges and a voltage is applied to a discharge space (i.e., between the two electrodes). When the voltage is applied to the discharge space, a discharge occurs through alpha and gamma processes and wall charges accumulate on the dielectric layers of the two electrodes. The accumulated wall charges reduce the voltage applied to the inside of the discharge space. As a considerable quantity of wall charges accumulate, the voltage applied to the discharge space is diminished as the wall charges gradually quench the discharge.

The following scenarios may take place for this process.

In the first scenario, the electrodes of the plasma display panel are coupled to the power source during substantially the whole discharge period as in the reset method of the prior art.

As a discharge occurs, wall charges accumulate on the dielectric layers formed in the electrodes. However, the voltage of the electrodes is maintained substantially constant with the applied voltage, because electric charges are continuously being supplied from the power source. The quantity of electric charges supplied to the electrodes from the power source is almost equal to that of wall charges accumulated by the discharge, so the internal voltage drop of the discharge space caused by the wall charges is very insignificant. Accordingly, a considerable amount of accumulated wall charges are needed to quench the discharge.

In the second scenario, the electrodes are floated after applying a voltage and the electrodes are electrically isolated from the power source as in the embodiment of this invention.

As a discharge occurs and wall charges accumulate, the voltage of the electrodes is changed according to the quantity of the accumulated wall charges because there is no electric charge supplied to the electrodes from the power source. The quantity of the accumulated wall charges reduces the interval voltage of the discharge space, so the discharge is quenched with a small quantity of wall charges. When a predetermined voltage is applied to the electrodes and then the power source and the panel are put in an open-circuit (high impedance) condition to IS float the electrodes, the voltage between the electrodes is reduced with a decrease in the internal voltage of the discharge space by the accumulation of the wall charges, thereby quenching the discharge with a small quantity of the wall charges. Accordingly, the wall charges can be controlled more precisely by floating the electrodes than by applying a voltage to the electrodes.

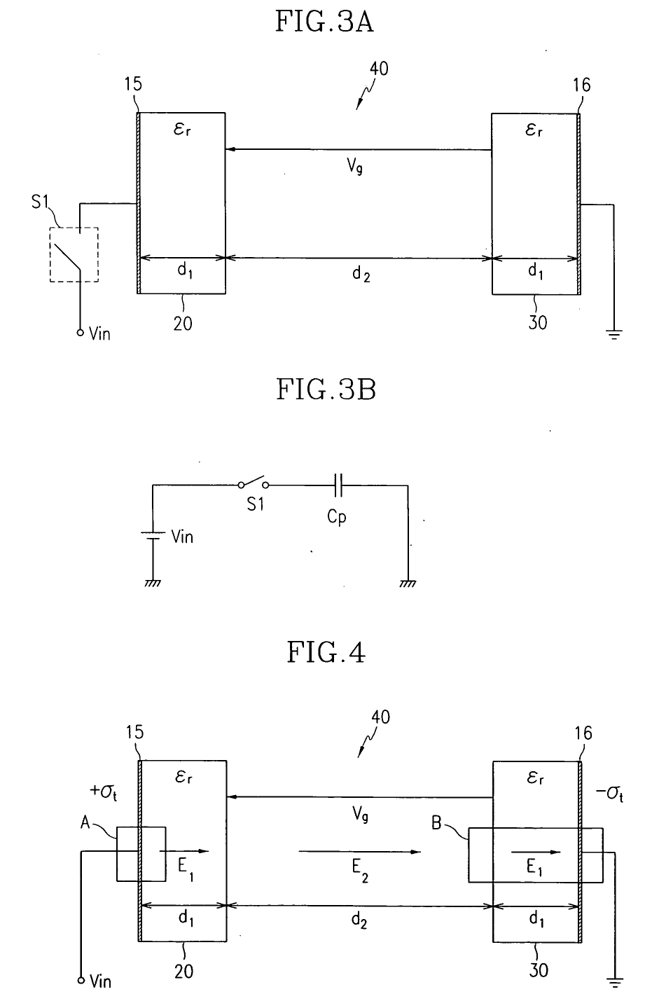

Now, the principle of the driving method according to an embodiment of the present invention will be described in further detail with reference to FIGS. 3A, 3B, 4, 5 and 6.

FIG. 3A shows the one-dimensional model of a PDP cell for explaining the driving method according to the embodiment of this invention, and FIG. 3B is an equivalent circuit diagram of FIG. 3A.

Referring to FIG. 3A, a first electrode (e.g., Y electrodes) 15 is coupled to a voltage Vᵢₙ through a switch S₁, and a second electrode (e.g., X electrodes) 16 is coupled to a ground voltage. Dielectrics 20 and 30 are formed on the first and second electrodes 15 and 16, respectively. Between the dielectrics 20 and 30 a discharge gas (not shown) is injected, and the region between the dielectrics 20 and 30 is defined as a discharge space 40.

The first electrode 15 and the second electrode 16, the dielectrics 20 and 30, and the discharge space 40 are represented as a panel capacitance Cp in the equivalent circuit diagram of FIG. 3B.

In FIG. 3A, the two dielectrics 20 and 30 are of the same thickness d₁ and are separated from each other at a predetermined distance (the distance of the discharge space) d₂. The dielectric constant of the two dielectrics 20 and 30 is ε_{γ}, and the voltage applied to the discharge space 40 is V_{g}.

Next, reference will be made to FIG. 4 to calculate the voltage V_{g} applied to the discharge space when the voltage Vᵢₙ is applied to the electrodes without accumulating wall charges.

Referring to FIG. 4, areas A and B are selected through the Gaussian surface from the Maxwell equation expressed by Equation 1, shown below. Applying the Gaussian theorem to the areas A and B derives Equations 2 and 3, which determine the electric field E₁ in the dielectrics and the electric field E₂ in the discharge space, respectively.

∇·D=∇·(εE)=σ Equation 1

$$\begin{matrix}Equation 2 \text{:} \\ {E}_{1} = \frac{{σ}_{t}}{{ϵ}_{γ} {ϵ}_{0}}\end{matrix}$$

where σₜ is the charge applied to the electrodes.

$$\begin{matrix}Equation 3 \text{:} \\ {E}_{2} = \frac{{σ}_{t}}{{ϵ}_{0}}\end{matrix}$$

The externally applied voltage Vᵢₙ, shown in FIG. 4, may be used to derive Equations 4 and 5, shown below.

2d₁E₁+d₂E₂=Vᵢₙ Equation 4

V_{g}=d₂E₂ Equation 5

From the Equations 1 through 5, Equations 6 and 7, shown below, can be derived.

$$\begin{matrix}Equation 6 \text{:} \\ {σ}_{t} = \frac{{V}_{i n}}{\frac{{d}_{2}}{{ϵ}_{0}} + \frac{2 {d}_{1}}{{ϵ}_{γ} {ϵ}_{0}}} \\ Equation 7 \\ {V}_{g} = {d}_{2} {E}_{2} = {d}_{2} \frac{{σ}_{1}}{{ϵ}_{0}} = \frac{{d}_{2}}{{d}_{2} + \frac{2 {d}_{1}}{{ϵ}_{γ}}} {V}_{i n} = \frac{{ϵ}_{γ} {d}_{2}}{{ϵ}_{γ} {d}_{2} + 2 {d}_{1}} {V}_{i n} = α {V}_{i n}\end{matrix}$$

where d₂ is much greater than d₁, so α approximates 1.

It can be seen from the Equation 7 that almost all of the externally applied voltage Vᵢₙ is applied to the discharge space.

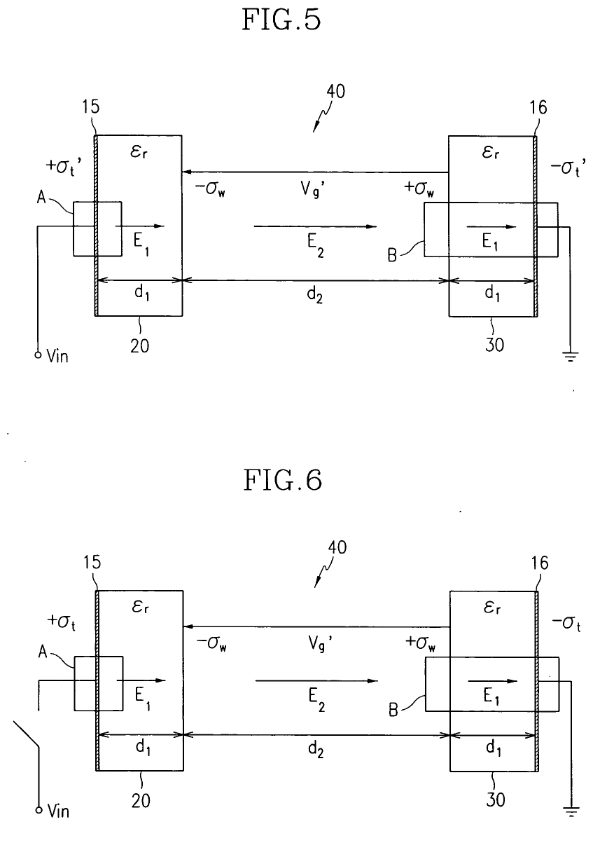

Next, reference will be made to FIG. 5 to calculate the internal voltage V_{g}′ of the discharge space when the wall charge σ_{w} is formed with the voltage Vᵢₙ applied. In FIG. 5, the charge applied to the electrodes is increased to σₜ′ because the power source supplies electric charges to the electrodes to maintain the potential of the electrodes substantially constant during the formation of the wall charge.

Referring to FIG. 5, areas A and B are selected through the Gaussian surface. Applying the Gaussian theorem to the areas A and B derives the Equations 8 and 9, shown below, which determine the electric field E₁ in the dielectrics 20 and 30 and the electric field E₂ in the discharge space, respectively.

$$\begin{matrix}Equation 8 \text{:} \\ {E}_{1} = \frac{{σ}_{t}^{′}}{{ϵ}_{γ} {ϵ}_{0}} \\ Equation 9 \text{:} \\ {E}_{2} = \frac{( {σ}_{t}^{′} - {ϵ}_{w} )}{{ϵ}_{0}}\end{matrix}$$

Because 2d₁E₁+d₂E₂=Vᵢₙ and V_{g}′=d₂E₂, Equations 10 and 11, shown below, can be derived from Equations 8 and 9.

$$\begin{matrix}Equation 10 \text{:} \\ {σ}_{t}^{′} = \frac{{V}_{i n} + \frac{{d}_{2}}{{ϵ}_{0}} {σ}_{w}}{\frac{{d}_{2}}{{ϵ}_{0}} + \frac{2 {d}_{1}}{{ϵ}_{γ} {ϵ}_{0}}} = \frac{{V}_{i n}}{\frac{{d}_{2}}{{ϵ}_{0}} + \frac{2 {d}_{1}}{{ϵ}_{γ} {ϵ}_{0}}} + α {σ}_{w} = \frac{{ϵ}_{0}}{{d}_{2}} {V}_{g} + α {σ}_{w} \\ Equation 11 \text{:} \\ {V}_{g}^{′} = {d}_{2} {E}_{2} = {d}_{2} \frac{{σ}_{t}^{′} - {σ}_{w}}{{ϵ}_{0}} = {V}_{g} + \frac{{d}_{2}}{{ϵ}_{0}} α {σ}_{w} - \frac{{d}_{2}}{{ϵ}_{0}} {σ}_{w} = {V}_{g} - \frac{{d}_{2}}{{ϵ}_{0}} {σ}_{w} ( 1 - α )\end{matrix}$$

As can be seen from the Equation 11, α approximates 1 when the voltage Vᵢₙ is applied, and an insignificant voltage drop occurs.

Next, reference will be made to FIG. 6 to calculate the interval voltage V_{g}′ of the discharge space when the wall charge σ_{w} is formed and the electrodes are floated after application of the voltage Vᵢₙ. In FIG. 6, the charge applied to the electrode becomes σₜ, because there is no electric charge supplied from the power source Vᵢₙ during the formation of the wall charge.

Referring to FIG. 6, areas A and B are selected through the Gaussian surface. Applying the Gaussian theorem to the areas A and B derives the Equations 2 and 12, shown below, which determine the electric field E1 in the dielectrics and the electric field E2 in the discharge space, respectively.

$$\begin{matrix}Equation 12 \text{:} \\ {E}_{2} = \frac{( {σ}_{t} - {σ}_{w} )}{{ϵ}_{0}}\end{matrix}$$

Because V_{g}′=d₂E₂, Equation 12 can be rewritten as the following Equation 13.

$$\begin{matrix}Equation 13 \text{:} \\ {V}_{g}^{′} = {d}_{2} {E}_{2} = {d}_{2} \frac{{σ}_{t} - {σ}_{w}}{{ϵ}_{0}} = {V}_{g} - \frac{{d}_{2}}{{ϵ}_{0}} {σ}_{w}\end{matrix}$$

As can be seen from Equation 13, a high voltage drop occurs due to the wall charge when the voltage Vᵢₙ is not applied (i.e., while the electrodes are in the floating state). Namely, Equations 11 and 13 show that a voltage drop caused by the wall charge when the electrodes are floating is 1/(1−α) times greater than a voltage drop when the voltage Vᵢₙ is applied to the electrodes. Accordingly, a small quantity of wall charges additionally accumulate on the dielectrics formed when the electrodes are in a floating state rapidly reduces the internal voltage of the discharge space and functions as a rapid discharge-quenching mechanism.

This quenching mechanism is used to precisely control the wall charge in the embodiment of this invention.

Next, a description will be given as to a method for driving a PDP according to a first embodiment of the present invention.

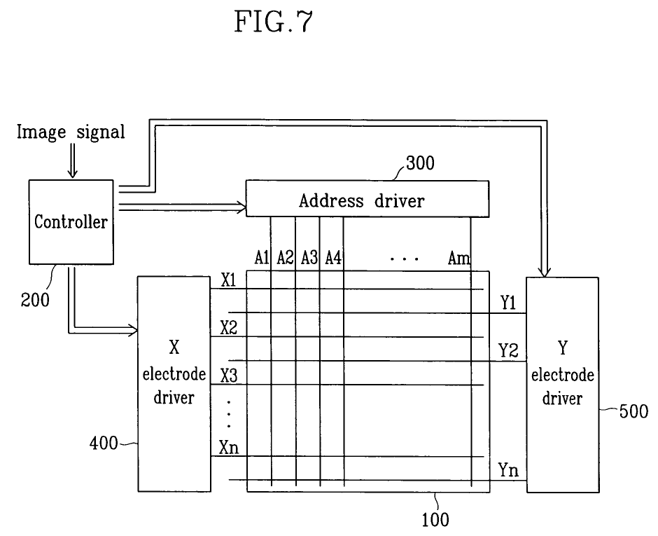

FIG. 7 is an illustration of a PDP according to an embodiment of the present invention.

The PDP according to the embodiment of this invention comprises a plasma panel 100, a controller 200, an address driver 300, an X electrode driver 400, and a Y electrode driver 500.

The plasma panel 100 includes a plurality of address electrodes A1 to Am arranged in columns, and a plurality of sustain electrodes X1 to Xn and scan electrodes Y1 to Yn, which are alternately arranged in rows.

The controller 200 externally receives image signals and outputs an address drive control signal 210, an X electrode drive control signal 220, and a Y electrode drive control signal 230.

The address driver 300 receives the address drive control signal 210 from the controller 200 and applies to the individual address electrodes a display data signal for selection of discharge cells to be displayed.

The X electrode driver 400 receives the X electrode drive control signal 220 from the controller 200 and applies a driving voltage to the X electrodes. The Y electrode driver 500 receives the Y electrode drive control signal 230 from the controller 200 and applies a driving voltage to the Y electrodes. The X electrode driver 400 or the Y electrode driver 500 applies a predetermined voltage to the X electrodes or the Y electrodes during the reset interval to cause a discharge and then floats the respective electrodes. The X electrode driver 400 or the Y electrode driver 500 also applies a sustain voltage to the X electrodes or the Y electrodes in the sustain interval.

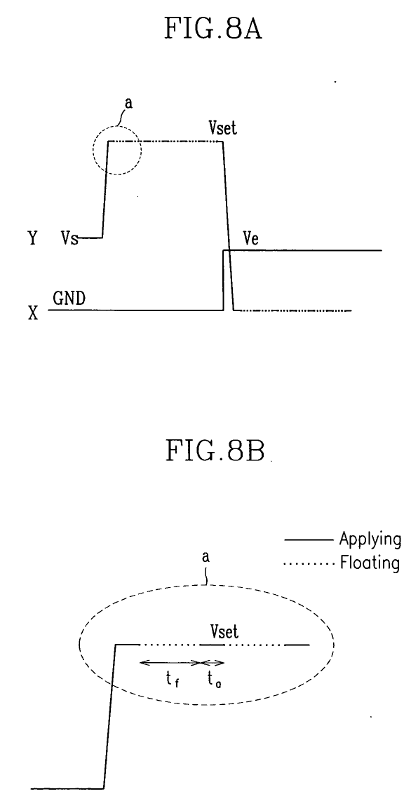

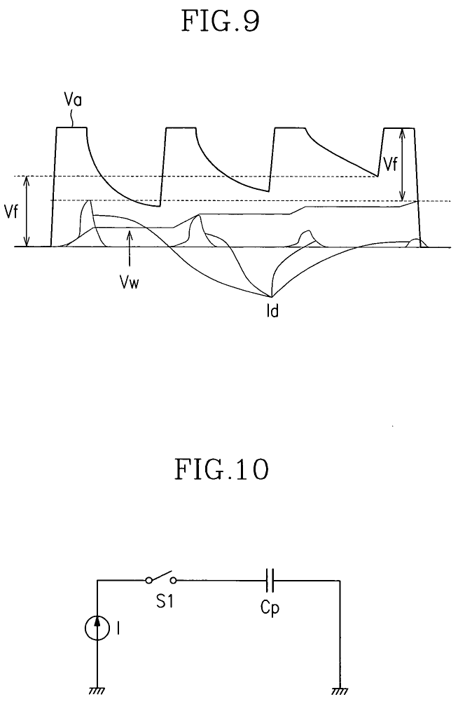

FIGS. 8A and 8B are reset waveform diagrams according to the driving method of the first embodiment of the present invention.

As illustrated in FIG. 8A, according to the reset waveform in the first embodiment of the present invention, a voltage Vₛₑₜ is applied to the Y electrodes with the X electrodes sustained at the ground voltage to cause a discharge, and the Y electrodes are then floated. The voltage-applying and electrode-floating procedure is repeatedly performed a predetermined number of times to drive the Y electrodes. In this case, as shown in FIG. 8B, the voltage-applying interval tₐ is less than the electrode-floating interval t_{f}.

FIG. 9 shows the difference voltage Vₐ between the X electrodes and the Y electrodes, the wall voltage V_{w} caused by the accumulated wall charges on the dielectric layers of the two electrodes, and the discharge current I_{d}, when the voltage-applying and electrode-floating procedure is repeatedly performed to drive the Y electrodes, as illustrated in FIGS. 8A and 8B. In the following description, the voltage Vₐ will be considered to be the Y electrode voltage because the X electrode voltage is the ground voltage in the first embodiment of this invention.

Referring to FIG. 9, when the voltage Vₛₑₜ exceeding a discharge firing voltage V_{f} is applied to the Y electrodes to activate a discharge and the Y electrodes are then floated, a specific quantity of wall charges accumulate and an intense discharge quenching occurs in the discharge space, as described previously. With the discharge quenching in the discharge space, the Y electrode voltage Vₐ decreases. Subsequently, the voltage Vₛₑₜ is applied to the Y electrodes to cause a second discharge and the Y electrodes are then floated, accumulating a specific quantity of wall charges and causing an intense discharge quenching in the discharge space. The voltage-applying and electrode-floating procedure is repeatedly performed a predetermined number of times.

As can be seen from FIG. 9, the quantity of discharge (i.e., the magnitude of the discharge current) in the discharge space slowly decreases. This is because the discharge current I_{d} flowing in the discharge space is proportional to the difference between the Y electrode voltage Vₐ and the wall voltage V_{w}. As the voltage-applying and electrode-floating procedure is repeatedly performed to drive the Y electrodes, as shown in FIG. 9, the wall voltage V_{w} caused by the wall charges accumulated on the dielectric layers of the two electrodes increases, and the difference between the Y electrode voltage Vₐ and the wall voltage V_{w} decreases, thereby reducing the discharge current I_{d}. In the meantime, the wall charges are accumulated until the voltage (i.e., the voltage difference between Vₐ and V_{w}) applied to the discharge space reaches the discharge firing voltage V_{f}.

The first embodiment of this invention, as described above, rapidly quenches the discharge with a small quantity of wall charges by applying a predetermined voltage Vₛₑₜ to the Y electrodes and then floating the Y electrodes to drive the Y electrodes. In this manner, the wall charges can be controlled precisely. For controlling the wall charges, according to the first embodiment of this invention, the voltage-applying time tₐ should not be long enough to cause an excessively intense discharge.

In addition, the first embodiment of the present invention allows stable control for the wall charges through a second discharge because the first discharge is the most intense. In an embodiment of this invention, the Y electrodes may be driven with the voltage-applying time (i.e., the turn-in time) and the floating time (i.e., the turn-off time) set to cause at least two discharge times.

Next, a description will be given as to a driving method according to a second embodiment of this invention.

FIG. 10 is a conceptual diagram of a circuit implementing the reset method according to the second embodiment of this invention.

Referring to FIG. 10, a current source I for flowing a constant current is coupled to a panel capacitor C_{P} through a switch S₁. The panel capacitor C_{P} is equivalent to the two of the Y electrodes, the X electrodes and the address electrodes. The voltage applied to the one electrode of the panel capacitor C_{P} with the switch on is given by the following equation:

V=±(I/Cₓ)·t Equation 14

where Cₓ represents the capacitance of the panel capacitor C_{P}; and the signs (+) and (−) are determined according to the direction of the current supplied from the current source I.

As can be seen from Equation 14, a ramp waveform rising with a slope of I/Cₓ is applied to the panel capacitor C_{P} in the second embodiment of this invention.

The reset method according to the second embodiment of the present invention involves applying a ramp waveform rapidly rising or rapidly falling for a predetermined time period to the one electrode of the panel capacitor to cause a discharge in the panel capacitor (i.e., a discharge space between the two electrodes) and then floating the one electrode of the panel capacitor to quench the discharge in the discharge space.

The circuit components corresponding to the current source I and the switch S₁ in the equivalent circuit of FIG. 10 can be presented in at least one of the X electrode driver 400, the Y electrode driver 500 and the address driver 300 of the plasma display panel shown in FIG. 7. The specific circuit of the current I and the switch S₁ in the equivalent circuit of FIG. 10 are well known to those skilled in the art and will not be described.

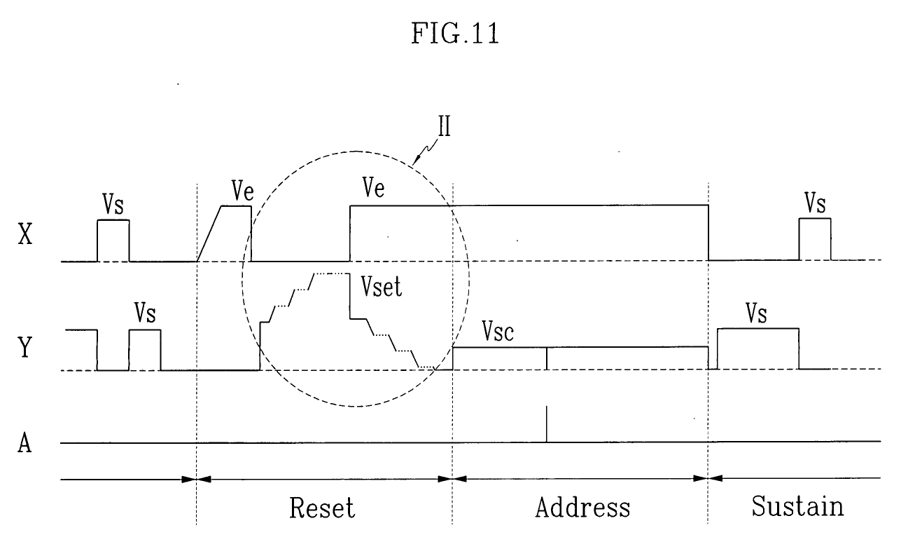

FIG. 11 is a driving waveform diagram according to the second embodiment of the present invention. Referring to FIG. 11, the reset interval comprises an erase interval, a Y rising-ramp/floating interval, and a Y falling-ramp/floating interval. A brief description of each of the intervals is provided below.

(1) Erase Interval

After the completion of the sustain, positive (+) and negative (−) charges are accumulated on the dielectrics formed in the X and Y electrodes, respectively. With the Y is electrodes sustained at a predetermined voltage (e.g., the ground voltage) after the sustain, a ramp voltage rising from 0(V) to+Ve(V) is applied to the X electrodes. Then the wall charges accumulated on dielectrics formed with the X and Y electrodes are erased slowly.

(2) Y Rising-Ramp/Floating Interval

With the address electrodes and the X electrodes sustained at 0V, a ramp-rising/floating voltage for repeatedly performing the procedure of rising ramp from Vₛ to Vₛₑₜ and then floating the Y electrodes is applied to the Y electrodes. A reset discharge occurs in all the discharge cells to accumulate wall charges while the rapidly rising ramp voltage is applied to the Y electrodes, and the discharge in the discharge space is rapidly quenched while the Y electrodes are floated.

(3) Y Falling-Ramp/Floating Interval

With the X electrodes sustained at a constant voltage Vₑ, a falling-ramp/floating voltage for repeatedly performing the procedure of falling ramp from Vₛ to V₀ and then floating the Y electrodes is applied to the Y electrodes.

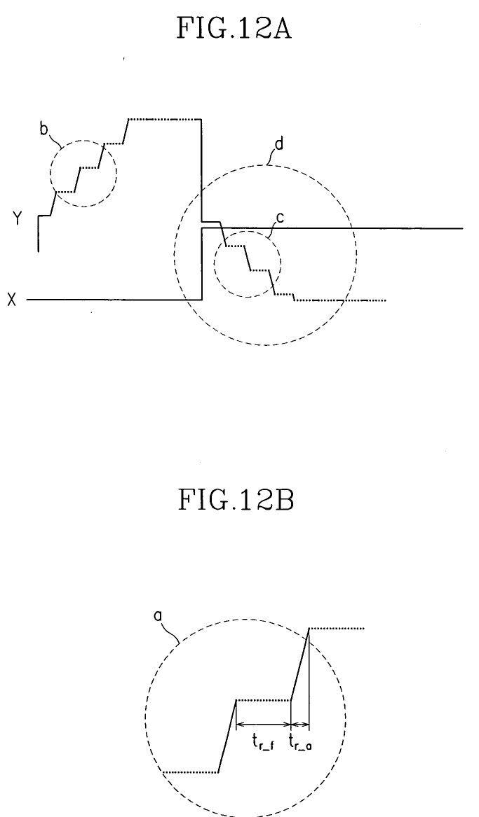

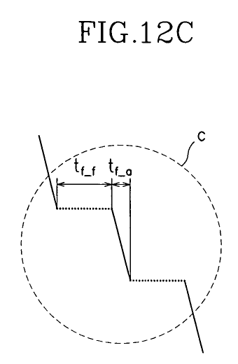

FIG. 12A is an enlarged diagram of the area II of the reset interval shown in FIG. 11, i.e., the Y rising-ramp/floating interval and the Y falling-ramp/floating interval; and FIGS. 12B and 12C are enlarged diagrams of the areas b and c in FIG. 12A, respectively.

In FIGS. 12B and 12C, the time tᵣ_{_{—}}ₐ for applying the rising ramp voltage to the Y electrodes and the time t_{f}_{_{—}}ₐ for applying the falling ramp voltage to the Y electrodes are preferably less than the times tᵣ_{_{—}}_{f} and t_{f}_{_{—}}_{f} for floating the Y electrodes, respectively. When the time-varying voltage is applied to Y electrodes (that is, panel capacitor), electric charge is supplied in the discharge space, thereby less quenching the stored wall charge. Therefore, it is desirable that the time-varying voltage with sharp slope is applied to the electrodes.

In the second embodiment, the slope of the time-varying voltage is greater than 10V/μsec. c.

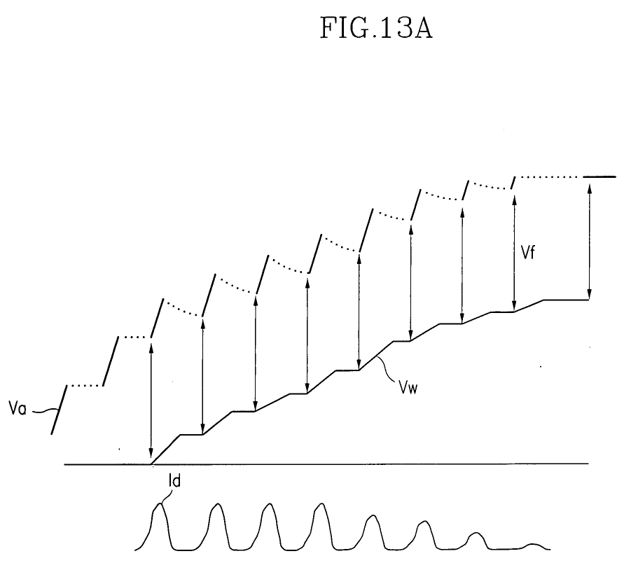

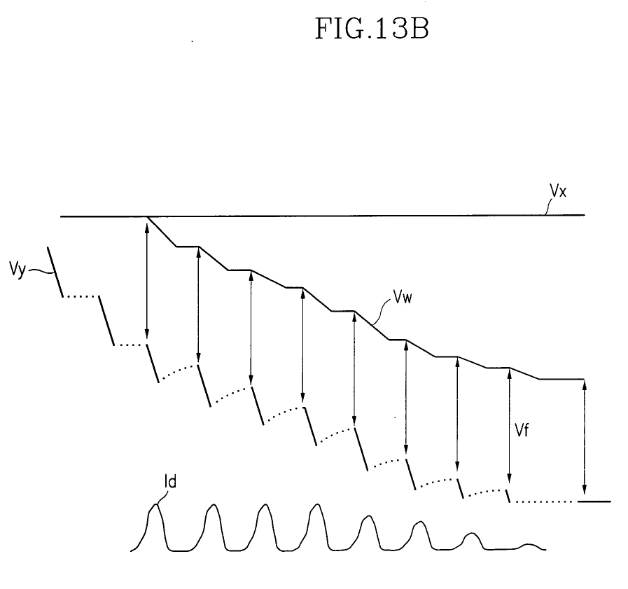

FIG. 13A shows the difference voltage Vₐ between the X and Y electrodes, the wall voltage V_{w} caused by wall charges accumulated on the dielectrics formed with the two electrodes, and the discharge current I_{d} in the Y rising-ramp/floating interval according to the second embodiment of the present invention. In the following description, for exemplary purposes, the voltage Vₐ is considered as the Y electrode voltage in the second embodiment of the present invention because the X electrode voltage is the ground voltage in the Y rising-ramp/floating interval.

As illustrated in FIG. 13A, when a ramp voltage exceeding the discharge firing voltage V_{f} is applied to the Y electrodes to cause a discharge and the Y electrodes are then floated, a specific quantity of wall charges are accumulated and an intense discharge quenching occurs in the discharge space, as described previously. With the discharge quenching in the discharge space, the Y electrode voltage Vₐ decreases. Subsequently, the ramp voltage is applied to the Y electrodes a second time and then the Y electrodes are floated, thereby accumulating a specific quantity of wall charges and causing an intense discharge quenching in the discharge space. The voltage-applying and electrode-floating procedure is repeatedly performed at predetermined number of times.

As can be seen from FIG. 13A, the quantity of discharge (i.e., the magnitude of the discharge current) in the discharge space is more constant in the second embodiment of this invention than in the first embodiment. This is because the voltage Vₐ applied to the Y electrodes as well as the wall voltage V_{w} caused by the wall charges accumulated on the dielectrics formed with the two electrodes increases as the voltage-applying and electrode-floating procedure repeats, thus maintaining the difference between the Y electrode voltage Vₐ and the wall voltage V_{w} more constant, compared with the case of the first embodiment of this invention.

Accordingly, the reset method of the second embodiment of the present invention can control the wall charge more precisely than the first embodiment of the present invention.

FIG. 13B shows the X electrode voltage Vₓ, the Y electrode voltage V_{y}, the wall voltage V_{w} caused by wall charges accumulated on the dielectrics formed with the two electrodes, and the discharge current I_{d} in the Y falling-ramp/floating interval according to the second embodiment of the present invention. In the Y falling-ramp/floating interval, a bias voltage Vₓ higher than the Y electrode voltage is applied to the X electrodes.

As illustrated in FIG. 13B, a rapidly falling ramp voltage is applied to the Y electrodes to cause a discharge such that the difference between the X electrode voltage Vₓ and the Y electrode voltage V_{y} exceeds the discharge firing voltage V_{f}, and then the Y electrodes are floated to reduce the wall charges previously accumulated and to cause an intense discharge quenching in the discharge space. The Y electrode voltage V_{y} increases with the discharge quenching in the discharge space. Subsequently, a falling ramp voltage is applied to the Y electrodes to cause a discharge and then the Y electrodes are floated, decreasing further wall charges and causing an intense discharge quenching in the discharge space. As the voltage-applying and electrode-floating procedure is repeatedly performed a predetermined number of times, a specific quantity of wall charges accumulate on the dielectrics formed on the X and Y electrodes, as illustrated in FIG. 13B.

Accordingly, the wall charges accumulated on the dielectrics formed with the two electrodes can be controlled to be in a desired state by repeatedly performing the voltage-applying and electrode-floating procedure as in the second embodiment of this invention.

As described above, the reset method according to the embodiment of this invention controls the wall charge accumulated on the dielectrics formed with the electrodes by applying a voltage and then floating the electrodes. Some exemplary advantages of this invention are discussed below.

The conventional reset method is a sort of feedback method that basically applies a voltage to cause a discharge for accumulation of wall charges and reduces the internal voltage when the wall charges are sufficiently accumulated, to quench the discharge. Contrarily, the reset method using the floating state of the electrodes according to the embodiment of the present invention is a more effective feedback method that rapidly reduces the internal voltage with a small quantity of wall charges accumulated by floating the electrodes to cause a discharge quenching. Namely, the present invention quenches the discharge with a much smaller quantity of accumulated wall charges to allow a precise control of the wall charges, as compared with the convention method.

The conventional reset method of applying a ramp voltage slowly increases the voltage applied to the discharge space with a constant voltage variation to prevent an intense discharge and control the wall charge. This conventional method using the ramp voltage controls the intensity of the discharge with the slope of the ramp voltage and requires a restricted condition for the slope of the ramp voltage to control of the wall charge, taking too much time for the reset operation. Contrarily, the reset method using the floating state according to the embodiment of the present invention controls the intensity of the discharge using a voltage drop based on the wall charge, reducing the required time.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

Although the Y electrodes are floated to quench the discharge in the embodiment of the present invention, for example, any other electrode can be floated. In addition, the rising/falling ramp waveforms are used in the embodiment of this invention, but any other rising/falling waveform can be used.

As described above, this invention enables the precise control of wall charges and shortens the required time of the reset interval.

What is claimed is:

1. A method for driving a plasma display panel, which includes a first space defined by a first electrode and a second electrode, the method comprising:
applying a voltage between the first electrode and the second electrode to discharge the first space; and
floating the first electrode after applying the first voltage.

2. The method of claim 1, further comprising one of sustaining a voltage applied to the second electrode or floating the second electrode while floating the first electrode.

3. The method of claim 1, wherein the driving method is performed during a reset interval.

4. The method of claim 3, wherein the first electrode is a scan electrode, the second electrode is a sustain electrode.

5. The method of claim 4, wherein the voltage applying step and the floating step each comprise biasing the sustain electrode to a predetermined voltage.

6. The method of claim 1, wherein an interval for floating the first electrode is longer than an interval for applying the voltage to the first electrode.

7. The method of claim 1, further comprising repeating a predetermined number of times the voltage applying step and the floating step.

8. The method of claim 7, wherein the voltage is a predetermined voltage.

9. The method of claim 7, wherein the voltage is a time-varying voltage.

10. The method of claim 9, a slope of the time-varying voltage is greater than 10V/μsec.

11. The method of claim 9, wherein the voltage is a rising ramp voltage.

12. The method of claim 9, wherein the voltage is a falling ramp voltage.

13. The method of claim 7, wherein a discharge current flowing in the first space by the n-th voltage applying step is greater than a discharge current flowing in the first space by the (n+1)-th voltage applying step.

14. A method for driving a plasma display panel, which includes a first space defined by a first electrode and a second electrode, the method comprising: during a reset interval,
applying a rising voltage to the first electrode to discharge the first space;
floating the first electrode after applying the rising voltage to the first electrode;
applying a falling voltage to the first electrode to discharge the first space; and
floating the first electrode after applying the falling voltage to the first electrode.

15. The method of claim 14, further comprising one of sustaining a voltage being applied to the second electrode or floating the second electrode while floating the first electrode.

16. The method of claim 14, wherein the first electrode is a scan electrode, the second electrode is a sustain electrode.

17. The method of claim 14, further comprising repeating a predetermined number of times the rising voltage application step and the floating step.

18. The method as claimed in claim 13, further comprising repeating a predetermined number of times the falling voltage application step and the floating step.

19. A method for driving a plasma display panel, which includes a first space defined by a first electrode and a second electrode, the method comprising: during a reset interval,
performing a first discharge in the first space to accumulate wall charges on a dielectric formed on at least one of the first electrode and the second electrode;
quenching the first discharge;
performing a second discharge in the first space to accumulate wall charges on the dielectric formed on at least one of the first electrode and the second electrode; and
quenching the second discharge.

20. The method of claim 19, wherein a discharge quantity by the first discharge is greater than a discharge quantity by the second discharge.

21. The method of claim 19, further comprising repeating the second discharge step and the second quenching step until a wall voltage based on the wall charges accumulated on the dielectric formed on at least one of the first electrode and the second electrode reaches a first wall voltage.

22. The method of claim 21, wherein the first wall voltage is less than or equal to a difference voltage between a voltage of the first electrode and a voltage of the second electrode voltages minus a discharge firing voltage.

23. The method of claim 19, wherein no wall charge is accumulated in the first discharge quenching step and the second discharge quenching step.

24. The method of claim 19, wherein the first electrode is floated in the first discharge quenching step and the second discharge quenching step.

25. A method for driving a plasma display panel, which includes a first space defined by a first electrode and a second electrode, the method comprising:
during a reset interval,
performing a first discharge in the first space to decrease wall charges accumulated on a dielectric formed on at least one of the first electrode and the second electrode;
quenching the first discharge;
performing a second discharge in the first space to decrease wall the charges accumulated on the dielectric formed on at least one of the first electrode and the second electrode; and
quenching the second discharge.

26. The method of claim 25, further comprising repeating a predetermined number of times the second discharge step and the quenching of the second discharge step.

27. The method of claim 26, wherein each of the first discharge quenching step and the second discharge quenching step comprises floating the first electrode.

28. A plasma display panel, comprising:
a first electrode and a second electrode;
a first space defined by the first electrode and the second electrode; and
a driver circuit for sending a driving signal to the first electrode and the second electrode during a reset interval, the driver circuit applying a voltage to the first electrode to discharge the first space and then floating the first electrode.

29. The plasma display panel of claim 28, wherein the first electrode is a scan electrode, the second electrode is a sustain electrode.

30. The plasma display panel of claim 28, wherein the driver circuit drives the first electrode to make an interval for floating the first electrode longer than an interval for applying the voltage to the first electrode.

31. The plasma display panel of claim 28, wherein the driver circuit drives the first electrode so as to repeat applying the voltage and floating the first electrode a predetermined number of times.

32. The plasma display panel of claim 31, wherein the discharge current flowing in the first space by the n-th application of the voltage is greater than a discharge current flowing in the first space by the (n+1)-th application of the voltage.

33. The plasma display panel of claim 28, wherein the driver circuit comprises:
a supply voltage; and
a switch coupled between the supply voltage and the first electrode.

34. The plasma display panel of claim 28, wherein the driver circuit comprises:
a current source; and
a switch coupled between the current source and the first electrode.

35. A plasma display panel, comprising:
a first substrate and a second substrate;
a first electrode and a second electrode formed in parallel on the first substrate;
an address electrode formed on the second substrate;
a first space defined by the first electrode and the second electrode; and
a driver circuit for sending a driving signal to the first electrode, the second electrode and the address electrode during a reset interval, an address interval, and a sustain interval, the driver circuit, during the reset period, applying a rising voltage to the first electrode to discharge the first space, and then floating the first electrode.

36. The plasma display panel of claim 35, wherein the driver circuit drives the first electrode so as to repeat applying the rising voltage and floating the first electrode for predetermined number of times.

37. The plasma display panel of claim 35, wherein the driver circuit additionally applies a falling voltage to the first electrode to discharge the first space and then floats the first electrode.

38. The plasma display panel of claim 37, wherein the driver circuit drives the first electrode so as to repeat applying the falling voltage and floating the first electrode a predetermined number of times.

39. The plasma display panel of claim 35, wherein the driver circuit comprises:
a current source; and
a switch coupled between the current source and the first electrode.

40. A plasma display panel, comprising:
a first substrate and a second substrate;
a first electrode and a second electrode formed in parallel on the first substrate;
an address electrode formed on the second substrate;
a first space defined by the first electrode and the second electrode; and
a driver circuit for sending a driving signal to the first electrode, the second electrode and the address electrode during a reset interval, an address interval, and a sustain interval, the driver circuit, during the reset interval, applying a falling voltage to the first electrode to discharge the first space, and then floating the first electrode.

41. The plasma display panel of claim 40, wherein the driver circuit drives the first electrode so as to repeat applying the falling voltage and floating the first electrode a predetermined number of times.

42. The plasma display panel as claimed in claim 40, wherein the driver circuit comprises:
a current source; and
a switch coupled between the current source and the first electrode.
